(19) United States
(12) Patent Application Publication
(10) Pub. No.: US 2010/0231347 A1
(43) Pub. Date: Sep. 16, 2010

(54) TRIGGERING DEVICE FOR A THERMAL FUSE

(75) Inventors: Norbert Knab, Appenweier (DE); Georg Schulze-Icking-Konert, Buehlertal (DE); Thomas Mohr, Buehlertal (DE); Stefan Kotthaus, Sinzheim (DE); Nikolas Haberl, Sinzheim (DE); Stefan Stampfer, Bietigheim-Bissingen (DE); Michael Mueller, Rutesheim (DE); Peilei Chen, Vaihingen/Enz (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/593,103

(22) PCT Filed: Feb. 1, 2008
(86) PCT No.: PCT/EP2008/051241

§ 371 Date: May 21, 2010

(30) Foreign Application Priority Data
Mar. 26, 2007 (DE) 10 2007 014 336.4

(51) Int. Cl. H01H 85/02

(52) U.S. Cl. 337/143

(57) ABSTRACT

The invention relates to a triggering device (1) for a thermal fuse comprising an actuator (11), which is designed to trigger at a threshold temperature, and a conductive bridge element (6) that is attached and connected to multiple connector points (9) exclusively by means of detachable connecting elements (10) for current flow. According to the invention the connecting elements (1) fully detach the bridge element (6) when a threshold temperature is reached or exceeded so that, in case the actuator (11) is triggered, the bridge element (6) is detached from the connecting elements (10) in order to interrupt the current flow.

The invention concerns a triggering device for a thermal fuse, in particular for the use at high current devices.

In order to protect modules against overheating irreversible thermal fuses are required, which interrupt (trigger) a current delivering conductor at a too high ambient temperature. The thermal fuses are thereby construed in a way that the triggering temperature is not reached due to a possibly occurring current flow, so that it is ensured that they can be triggered not due to a too high current but only due to a too high ambient temperature. A thermal fuse serves also for providing an independent switch-off path for electric modules, which interrupts the current flow safely at an improperly high temperature in the module, for example due to failures of components, shorts, for example by external influence, malfunctioning of isolation material and such alike.

Usual thermal fuses are mostly based on the concept of a fixed spring (for example a soldered leaf spring), at which the fixture loosens (for example by melting) at a temperature influence, whereby the thermal fuse is opened by the spring force. But even in normal operation, which means in closed state of the thermal fuse, a mechanical force is thereby exerted on the connecting point, which can cause quality issues, especially at long operating times in the automotive field, for example to a rattling of the soldering point.

It is the task of the present invention to provide a thermal fuse, at which it is ensured, that the detaching exclusively takes place due to the ambient temperature and not due to a too high current flow through the fuse and whereby it is furthermore ensured, that a conductive element of the thermal fuse that is connected over a soldering connection is not en exposed to stress, which affects the solder connection, in order to ensure a longer lifetime.

This task is solved by the triggering device according to claim 1 as well as by the thermal fuse according to secondary claims.

Further advantageous embodiments of the invention are stated in the dependant claims.

According to a first aspect a triggering device for a thermal fuse is provided. The triggering device comprises an actuator, which is construed to trigger at a threshold temperature, and a conductive bridge element, which is attached and connected with a connecting area over a fusible connecting element at a connecting point, in order to deliver current. The connecting element is construed to melt when reaching or exceeding a threshold temperature, so that the bridge element is detached from the connecting element when triggering the actuator, in order to interrupt the delivery of current.

The triggering device according to the invention enables a reliable triggering when exceeding a threshold temperature in the surroundings of the triggering device. The interruption of a conductor during triggering takes place by separating the conductor at one or several points by lifting a bridge element, whereby the triggering can be ensured in a particularly reliable way.

Furthermore the actuator can provide a movable stamp in order to lift the connecting area of the bridge element from the connecting point when triggering.

According to a further embodiment the actuator can provide a melting body, which holds the stamp in a not triggered position, whereby the material of the melting body is selected in such way that it melts when reaching the threshold temperature and the actuator triggers thereby, whereby the stamp is moved by a force, in particular a spring force, in order to lift the bridge element completely from the connecting points with the aid of the stamp.

The actuator can furthermore provide two melting bodies, which are separated from each other and which are arranged as ring elements around the stamp. Alternatively the actuator can provide a circular melting body made of electrically isolating material, which is arranged as a ring around the stamp.

According to one embodiment the conducting bridge element can be attached and connected at several connecting areas by corresponding fusible connecting elements at corresponding connecting points, whereby the bridge element is completely detached from the connecting points when the actuator triggers, in order to interrupt the supply of current.

The stamp can grip through a fixture opening in the bridge element, in order to fix the bridge element when lifting from the connecting points.

The actuator can furthermore be construed to move against a stop plate when triggering, so that the bridge element is held between stamp and stop plate in triggered status.

Furthermore the conducting bridge element can be arranged pivoted at a further connecting point, whereby the actuator is arranged at the bridge element in such a way that the connecting area of the bridge element is lifted from the connecting point by a path when the actuator triggers, which is bigger than the stroke of the stamp of the actuator when triggering due to a leverage effect. That makes it possible to enlarge the way, by which the connecting area is lifted from the connecting point. That has the advantage that the connection can be reliably removed, because a solder may pull strings without soldering flux, which rip at an increased stroke.

The connecting area of the bridge element can furthermore be bent off from the bridge element and be led into a contact bridge through an opening.

The contact elements are preferably made of a conducting material, in particular a fusible metal or metal alloy.

According to a further aspect a thermal fuse is provided, which has the above triggering device, whereby the bridge element is connected at a contacting device, in particular at a punch grid or a conductor plate.

### DRAWINGS

Preferred embodiments of the invention are subsequently further explained with aid of the attached drawings. It is shown in:

FIG. 1 a cross sectional view of a triggering device according to a first embodiment of the invention;

FIG. 2 a top view on the triggering device from FIG. 1;

FIG. 3 a perspective view of the actuator, which is used at the embodiment of FIG. 1;

FIG. 4 a cross sectional view of a triggering device according to a further embodiment of the invention in a not triggered status; and

FIG. 5 a cross sectional view of a triggering unit according to the embodiment of FIG. 4 in a triggered status.

### EMBODIMENTS OF THE INVENTION

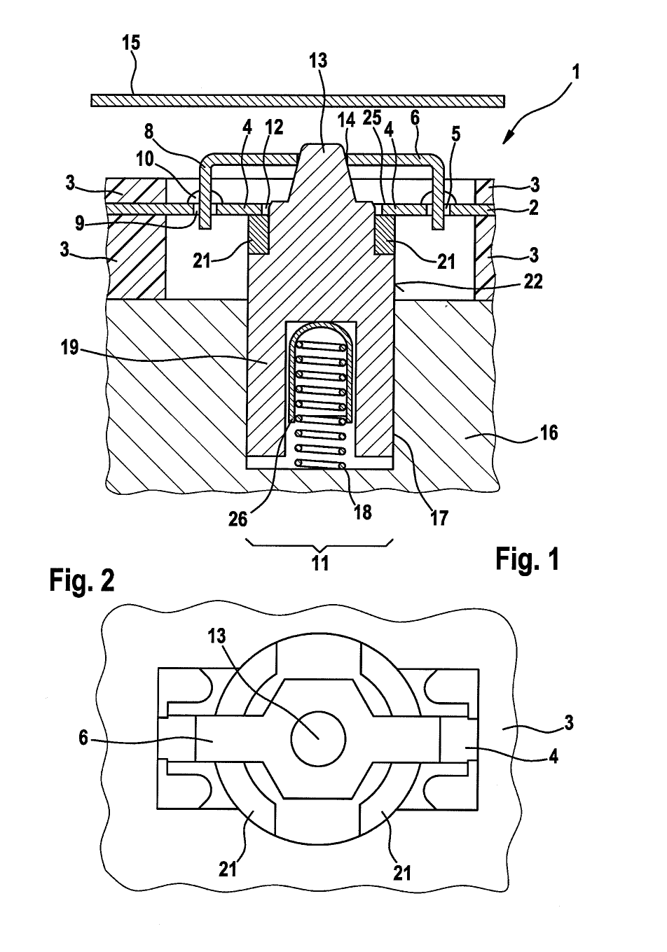

FIG. 1 shows the triggering device according to the invention. The triggering device 1 is attached at a punch grid 2 made of a conducting metal, which is surrounded by a sheathing 3 made of non-conducting plastic material. Instead of the punch grid 2 a conductor plate or another contacting device can also be provided.

In the area of the triggering device 1 the sheathing 3 of the punch grid 2 is removed, so that the punch grid 2 is exposed. In the area of the triggering device the laying open part of the punch grid 2 provides two contact bridges 4, which stick out in the recess 5. With the aid of a bridge element 6, which is conductively connected to the two contact bridges 4, a current connection is created, by which an electrical module, which is connected to the punch grid 2, is operated.

The bridge element 6 provides at two opposing end bent off connecting parts 8, which reach through the opening 9 in the contact bridges 4 of the punch grid 2 and is connected at these points by a solder connection 10 with the punch grid 2. The solder connection 10 provides a conducting contact between the bridge element 6 and the corresponding contact bridges 4 of the punch grid 2. Instead of the solder connection 10 another conducting connection can also be used, for example made of a metal or a metal alloy, whose melting temperature is equal to or lower than the temperature of the triggering.

Alternative contacts between the contact bridges 4 and the bridge element 6 are possible, as long as the enable a simple detaching of the bridge element 6 from the contact bridges 4 after a melting of the solder connection 10. Thus one or two connecting parts can also be put on corresponding connecting points on the contacts bridges 4 without having openings.

A gap 12 exists in the punch grid 2 between the ends of the contact bridges 4, through which a stamp 19 of the actuator 11 reaches and can be moved in a direction vertically to a main surface of the punch grid 2. The actuator 11 is generally so construed that it triggers when the ambient temperature of the triggering device 1 exceeds a certain threshold temperature, whereby the stamp 19 is moved vertically to the main surface of the punch grid 2.

The stamp 19 provides a conical engaging element 13, which is in contact with and sticks out through a fixture opening 14 of the bridge element 6. At a triggering of the actuator 11 the stamp 19 moves vertically to a main part of the bridge element 6, whereby the engaging element 13 lifts the bridge element 6 from the punch grid 2, so that the electrical connection between the contact bridges 4 is interrupted. In order simplify the lifting the bridge element 6 from the contact bridges 4 of the punch grid 2 the solder material of the solder connection 10 is selected so that it melts or already melted at the threshold temperature, at which a triggering of the triggering device 1 shall take place, after which the bridge element 6 can be easily lifted from the punch grid 2 by the stamp 19. Alternatively or additionally nominal separation points (not shown) can be provided in the bridge element 6, at which the bridge element 6 is separated by the force of the stamp 19 when the actuator 11 triggers.

A fixture device is provided in order for the bridge element 6, which lies loose on the contact bridges 4 of the punch grid 2 after melting, not to detach from it in the case of a triggering and not to get into the environment, where it can possibly cause shorts. The bridge element 6 lies loose on the engaging element 13 in the shown embodiment. If the actuator 11 triggers the bridge element 6 that is detached from the punch grid 2 is moved by the stamp 19 away from the punch grid 2. In the direction, in which the stamp 19 of the actuator 11 at a triggering, a stop plate 15 is located at the opposite side of the punch grid 2, which spans basically parallel to the punch grid 2. The engaging element 13 is moved and possibly pressed against this stop plate 15, without letting the bridge element 6 get outside the grip with the engaging element 13. In a triggered state one end of the engaging element 13 lies then on the stop plate 15 and reaches through the fixture opening 14 of the bridge element 6, so that it is held securely at the stop plate 15.

As described above the actuator 11 is construed to trigger at a certain ambient temperature. In the illustrated example the actuator 11 comprises the stamp 19, which is led in a recess 17 of an actuator housing 16 in the movement direction of the stamp 19. A spring element 18 is arranged between the ground of the recess 17 and a recess 20 of the end of the stamp 19 that is pointed towards the guide housing 16. In a not-triggered state the spring element 18 is pre-loaded, so that a force appears between the stamp 19 and the actuator housing 16. In a not-triggered state the stamp 19 is held in its position against the spring force by melting bodies 21. The melting bodies 21 are arranged between a stop edge 22 of the stamp 19 and a stop area 25 at the corresponding ends of the contact bridges 4 of the punch grid 2.

The stamp 19 is tapered in the area of the melting body 21, so that it can move through the opening of the punch grid 2 that is created by the contact bridges 4. The melting bodies 21 are created of an easily fusible material, as for example solder or wax, which melts in the case of a triggering can flow out in melted state through a gap 26 between the corresponding end of the contact bridges 4 and the stamp 19 of the actuator 11. Thereby the mechanical resistance between the stop edge 22 of the stamp 19 and the stop area 25 of the contact bridges 4 dissolves and the stamp 19 moves towards the stop plate 15.

The stamp 19 is preferably made of a non-conducting material, for example plastic or ceramic, so that no conducting connection is created after the triggering between the contact bridges 4. It avoids thereby furthermore a short by the spring element.

Instead of the spring element 18, which is construed as spiral spring in the described embodiment, a leaf spring can also be provided or another measure, as for example pressure air, which exerts a permanent force on the stamp 19 towards the melting body 21 and towards the bridge element 6.

The material of the melting body 21 is preferably so chosen that no plastic deformation occurs at temperature below the threshold temperature. This is especially the case when using metals or metal alloys. But it has to be regarded hereby that the melted material of the melting body 1 instead of the bridge element 6 does not create a contact between the contact bridges 4.

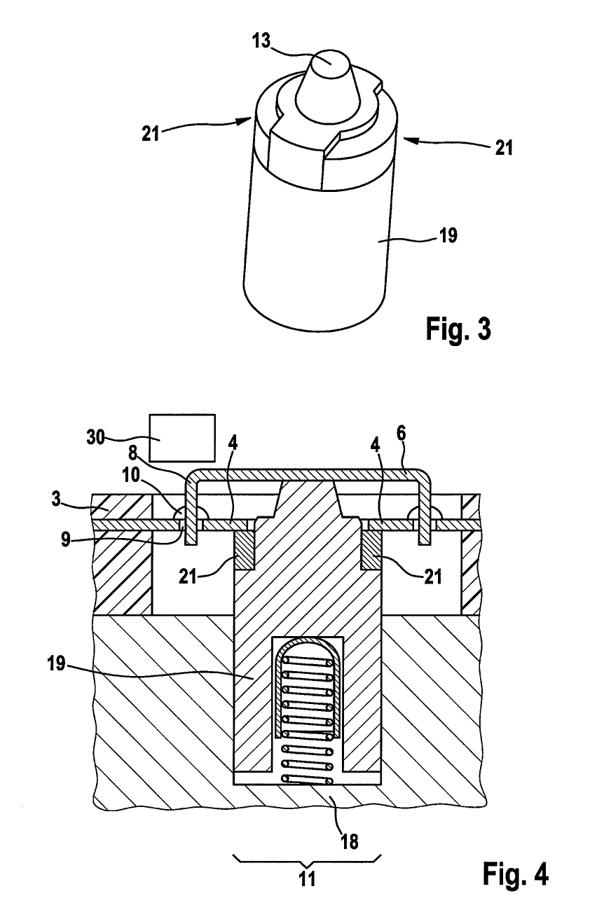

The two melting bodies 21 that are illustrated in the shown embodiment are circular and not in contact with each other, so that no accidental electric connection can be created over them. As it can be seen in FIG. 3 the stamp 19 provides therefore stop edges 22 along its dimensional direction, which is not completely surrounding and are separated from each other by the non-conducting material of the stamp 19. If a non-conducting material as for example wax is used as melting body 21 instead of a solder material such a partition of the stop edges 22 is not required and the melting body 21 can also be put as circular element around the corresponding part of the stamp 19, which simplifies the mounting of such a device.

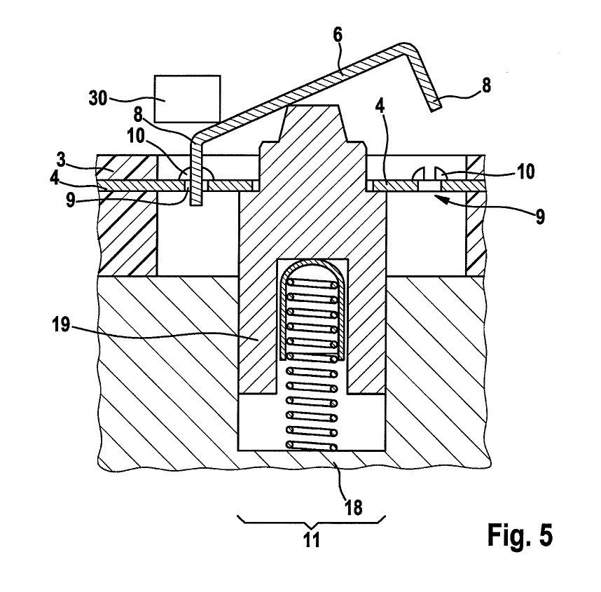

FIGS. 4 and 5 shows a triggering device is shown according to a further embodiment of the invention. The same reference signs are equivalent elements of the same or similar function.

The embodiment of FIGS. 4 and 5 distinguishes itself from the embodiment in FIGS. 1 and 2 thereby that the bridge element 6 is pivoted fixed at one end and stays fixed at a triggering, so that the bridge element moved around the so created pivot axle. Furthermore the embodiment of FIGS. 4 and 5 distinguishes itself from the embodiment of FIGS. 1 and 2 thereby that it is provided without a fixture opening. For creating the pivot axle a stop element 30 is provided instead of the stop plate 15, which fixes one end of the bridge element 6 in the opening of the contact bridge 4, so that it cannot be pulled out of the opening in case the stamp 19 moves. In the case of a triggering the connecting element 30 becomes liquid but the stop element 30 prevents that the corresponding connection area 8 is pulled out of the opening 9.

The stop element 30 defines thereby a pivot axle of the bridge element 6, around which the bridge element 6 is swiveled if the actuator 11 triggers (see FIG. 5). At a triggering the stamp 19 presses against the bridge element 6 so that it is swiveled around the pivot axle. A connecting area 8 is thereby pulled out of the opening 9 in the corresponding contact bridge 4 that is opposed to the fixed connecting area 8 and depending on the stroke of the stamp 19 displaced by a defined path length. The stamp 19 engages at the bridge element 6 between the two connecting areas, so that due to a leverage effect the path, by which the connecting area 8 is pulled out of the corresponding opening 9, is bigger than the stroke, which the stamp 19 travels at a triggering of the actuator 11. If the stamp 19 influence for example the bridge element 6 in the middle the connecting area is displaced from the corresponding opening by a path, which is approximately equivalent to the double stroke length of the stamp 19. Hereby the conductive connection that is created by the bridge element 6 can be reliably interrupted by separating the connecting area 8 and the connecting element 10 or the contact bridge 4 from each other by a large distance. This is in particular advantageous if it is possible that the melted solder of the connecting point 10 pulls strings when separating, which do not rip apart until a sufficiently large distance is reached between the connecting area 8 and connecting element 10. Thereby the connecting area 8 and the connection element 10 can be reliably separated from each other in order to achieve an interruption of the current flow through the bridge element 6.

Instead of the stop element 30, which is arranged in moving direction of the stamp 19 with regard to the corresponding opening in the contact bridge 4 when triggering, the first connecting area 8 can also be fixed at the contact bridge 4 by a widening on the side of the contact bridge 4 that is pointed towards the actuator 11. The fixture causes that the connecting area 8 cannot be pulled out of the corresponding opening 9 when the actuator 11 triggers, so that a pivot axle of the bridge element 6 is defined at the corresponding opening 9 of the contact bridge 4.

1-11. (canceled)

12. A triggering device for a thermal fuse, comprising:
an actuator configured to trigger at a threshold temperature; and
a conducting bridge element to deliver current attached and connected to a connecting point with a connecting area by a fusible connecting element;
wherein the connecting element is configured to melt upon reaching the threshold temperature to detach the bridge element from the connecting element when triggering the actuator to interrupt current delivery.

13. The triggering device of claim 12, wherein the actuator comprises a stamp configured to lift the connecting area of the bridge element from the connecting point when triggering.

14. The triggering device of claim 13, wherein the actuator further comprises a melting body that maintains the stamp in an untriggered position, wherein a material of the melting body is selected to melt upon reaching the threshold temperature and thereby trigger the actuator, wherein the stamp is actuated by a spring force to lift the bridge element with the aid of the stamp from the connecting points completely.

15. The triggering device of claim 14, wherein the actuator comprises two melting bodies that are separated from each other and are arranged as ring elements around the stamp.

16. The triggering device of claim 14, wherein the melting body comprises an electrically isolating material and is arranged as a ring around the stamp.

17. The triggering device of claim 12, wherein the conducting bridge element is attached and connected at corresponding connecting points with several connecting areas over corresponding fusible connecting elements, wherein the bridge element completely detaches the connecting areas from the connecting points when triggering the actuator to interrupt the delivery of the current.

18. The triggering device of claim 17, wherein the stamp is configured to grip through a holing opening in the bridge element to fix the bridge element when lifting from the connecting points.

19. The triggering device of claim 17, wherein the actuator is configured to move against a stop plate when triggering so that the bridge element is held between the stamp and stop plate in a triggered state.

20. The triggering device of claim 13, wherein the conducting bridge element is configured to be swiveled around a further connecting point, wherein the actuator is arranged at the bridge element such that when triggering, the actuator the connecting area of the bridge element is lifted from the connecting point by a way that is higher than a stroke of the stamp of the actuator when triggering via leverage.

21. The triggering device of claims 12, wherein the connecting area of the bridge element is bent off from the bridge element and led through an opening into a contact bridge.

22. The triggering device of claim 12, wherein the bridge element is connected to a contacting device comprising one of a punch grid and a conducting plate.
